(19) United States
(12) Patent Application Publication
(10) Pub. No.: US 2008/0275732 A1
(43) Pub. Date: Nov. 6, 2008

(54) Using patterns of medical treatment codes to determine when further medical expertise is called for

(75) Inventors: Kenneth H. Falchuk, Newton, MA (US); Jose A. Halperin, Brookline, MA (US); Luciano M. Grubissich, Brookline, MA (US)

Correspondence Address: GORDON E NELSON;PATENT ATTORNEY, PC, 57 CENTRAL ST, PO BOX 782, ROWLEY, MA, 01969, US

(73) Assignee: Best Doctors, Inc.

(21) Appl. No.: 11/742,832

(22) Filed: May 1, 2007

(51) Int. Cl. G06Q 50/00

(52) U.S. Cl. 705/3

(57) ABSTRACT

A technique for using ICD-9 and CPT codes in an individual's medical records to determine a particular manner in which a medical condition of an individual should be dealt with. The medical records are analyzed for a pattern of the medical treatment codes that is associated with the particular manner of dealing with the medical condition and an indication of the pattern's existence is provided. In one embodiment, the analysis is used to determine whether and what kind of specialist is required. The analysis may be performed when the diagnosis of the condition is uncertain, when the treatment of the condition is uncertain, when the treatment has resulted in further problems, or when the patient is not responding to the treatment.

### CROSS-REFERENCE TO RELATED APPLICATIONS

### STATEMENT REGARDING FEDERALLY SPONSORED RESEARCH OR DEVELOPMENT

Not applicable.

### REFERENCE TO A SEQUENCE LISTING

Not applicable.

### BACKGROUND OF THE INVENTION

1. Field of the Invention

The invention is addressed to techniques for diagnosing and managing medical conditions.

2. Description of Related Art

Medical diagnosis is conceptually quite simple: the doctor listens to the patient's description of his or her symptoms, examines the patient on the basis of the description, and then determines from the description of the symptoms, the examination, the doctor's knowledge of medicine, and the doctor's knowledge of the patient what the cause of the symptoms is. The diagnosis determines how the patient is treated, and the success of the diagnosis is measured by the success of the treatment. If the treatment does not cause the symptoms to go away, the doctor makes another attempt at diagnosis and may even call in a specialist.

Diagnosis and treatment done as described above works well in most cases. It is, however, necessarily limited by the doctor's knowledge of medicine and the doctor's knowledge of the patient. The rapid advance of medicine has made it impossible for even the best doctors to keep up in areas outside their specialties and the division of medicine into specialties, the mobility of the population, and the use of emergency rooms for primary care means that in many cases, a modern doctor has no long-term relationship with his or her patient. Another problem with diagnosis and treatment as done above is management of long-term chronic conditions. In the insurance context, this is often relegated to clerical employees who have no knowledge of the development of medicine, and even when the management is not relegated to such employees, it is rare that the diagnosis and treatment of the long-term chronic condition is reexamined in light of current medical knowledge.

Less than optimum diagnosis and/or treatment may have serious consequences both for the patient and the health care system. For example, if symptoms resulting from a cancer that is affecting the lungs are diagnosed as bronchitis, the delay in getting the right diagnosis may make successful treatment of the cancer far more difficult or even impossible. The consequences of less-than-optimum diagnosis and/or treatment for the health care system are shown in FIG. 1. Graph 101 in FIG. 1 shows the distribution of the cost of a medical insurance claim for a complex condition from the time payments begin to be made on the claim until the patient dies. A complex condition here and in the following is one for which diagnosis and treatment are substantially better when they are done by experts in the condition. The y axis is the cost 103 and the x axis is time 105. Current cost distribution 107 shows the distribution of the costs when the diagnosis and management of the complex condition is done without the advice of the experts in the condition. As can be seen there, current cost distribution 107 has a number of peaks: a large peak 109 at the time of initial diagnosis and treatment, peaks 111 for periodic acute complications during the patient's life, and then a final peak 113 at the end of the patient's life. Expert effect 115 shows what happens when doctors who are experts deal with the condition: the costs are less throughout the patient's life, the peak at the time of initial diagnosis and treatment is substantially smaller, and the peaks 111 and 113 are eliminated. To the extent that there is a correlation between the amount of medical effort expended and pain and suffering on the part of the patient, expert effect 115 not only reduces costs, but improves the patient's quality of life.

The problem posed by the graph of FIG. 1 is figuring out when a complex medical condition exists. Where the condition is not complex, for example, the symptoms are in fact the result of bronchitis, not cancer, there is no need to consult the experts and doing so not only increases the cost of care but also misallocates the experts time. Moreover, as the graph of FIG. 1 shows, the greatest impact of the expert effect comes when the expert is available for initial diagnosis and treatment. Because that is the case, a better way of figuring out whether a complex medical condition exists is needed than simply waiting to see whether the treatment resulting from the original diagnosis works and consulting an expert when it does not. What is needed then is a technique for determining with a high degree of probability whether a medical condition is in fact a complex medical condition. It is an object of the invention described in the following to provide such a technique. Other objects include using the technique to reduce the cost of medical treatment and using the technique as part of the process of referring an individual to a specialist.

### BRIEF SUMMARY OF THE INVENTION

One of the objects of the invention is attained by a method of determining a particular manner in which a medical condition of an individual should be dealt with. The determination is made from a set of medical records that belong to the individual and contain medical treatment codes. The steps of the method include:
analyzing the set of medical records to determine whether the set of medical records contains a pattern of the medical treatment codes that is associated with the particular manner of dealing with the medical condition; and
when the set of medical records does contain such a pattern, providing an indication of the pattern's existence.

In other aspects of the foregoing invention, the particular manner of dealing with the medical condition is consulting an expert. The expert may belong to a class of experts that is associated with the pattern of the medical treatment codes.

The method further comprises the step of responding to the indication of the pattern's existence by dealing with the medical condition in the particular manner associated with the pattern of the medical treatment codes.

The analysis of the set of medical records can be made at a number of points during the medical condition. The pattern of medical treatment codes and the particular manner of dealing with the medical condition depend on when the analysis is made. The analysis may be made when the diagnosis of the medical condition is uncertain, when the treatment of the medical condition is uncertain, when the treatment results in further problems, or when the individual does not respond to the treatment.

The individual may further be one of a first set of individuals. The step of analyzing is done for each of the individuals in the first set and in the step of providing an indication, individuals whose medical records do contain a pattern of the medical treatment codes that is associated with the particular manner of dealing with the medical condition are placed in a second set of individuals.

In one implementation of the method, the set of medical records is contained in a database system and the step of analyzing includes the steps of querying the set of records with a query based on the pattern of the medical treatment codes and determining from the result of the query whether the set of records does contain such a pattern.
A method of reducing the cost of a treatment of a medical condition of an individual includes the steps of analyzing the set of medical records to determine whether the set of medical records contains a pattern of the medical treatment codes that indicates that the medical condition is a complex medical condition; and
when the set of medical records does contain such a pattern, indicating that an expert should be consulted concerning the medical condition.

Other aspects of the foregoing invention are similar to those set forth for the method of claim 1.

A method of providing expert medical intervention with regard to a medical condition in an individual includes the following steps:
analyzing a set of medical records for the individual to determine whether the set of medical records contains a pattern of medical treatment codes which indicates that the medical condition requires a particular type of expert intervention of a particular type; and
if the set of medical records does contain such a pattern, referring the individual to an expert who can provide the particular type of intervention.

Other aspects of this invention include the additional step of collecting the medical records belonging to the set and the additional steps of making a package of information from the additional medical information and from the medical records which presents the information a way that is optimal for the expert to whom the individual is being referred and providing the package to the expert to whom the individual is being referred.

Other objects and advantages will be apparent to those skilled in the arts to which the invention pertains upon perusal of the following Detailed Description and drawing, wherein:

### BRIEF DESCRIPTION OF THE SEVERAL VIEWS OF THE DRAWINGS

FIG. 1 is a graph showing a cost distribution for a complex medical claim.

FIGS. 2A and 2B show a table of frequently-misdiagnosed or mistreated conditions.

FIG. 3 show ideal stages for expert intervention in the treatment of a complex medical condition.

FIG. 4 shows times to look for complex conditions.

FIG. 5 shows how ICD-9 and CPT codes can be used to determine whether a sarcoma has been properly diagnosed and treated.

FIG. 6 is a database system in which a system for determining whether a medical condition is a complex medical condition is implemented.

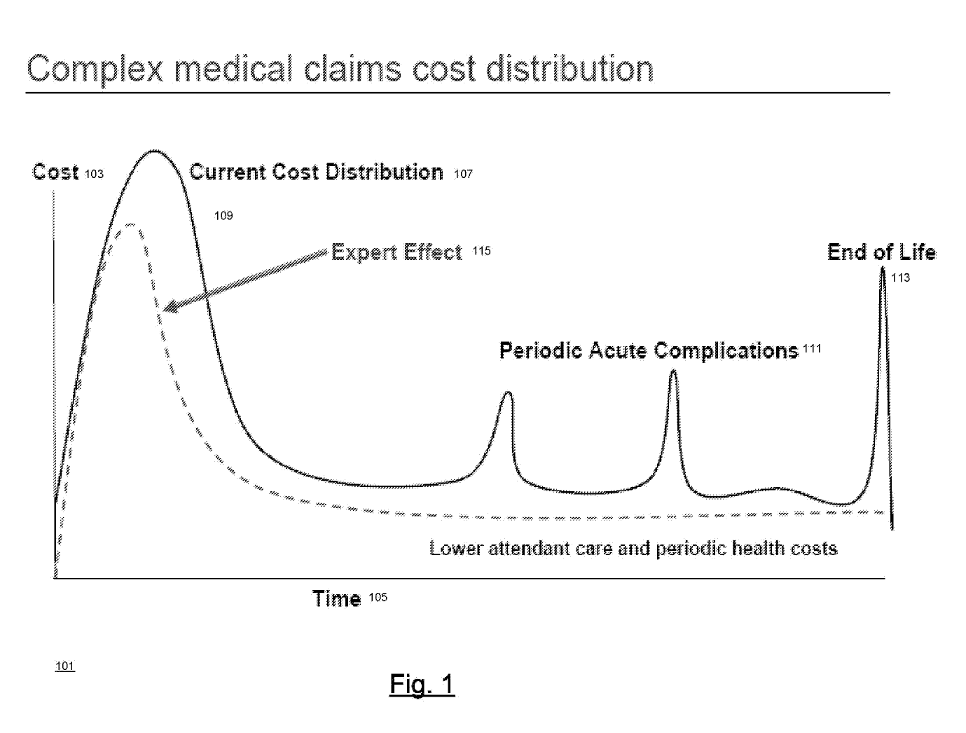

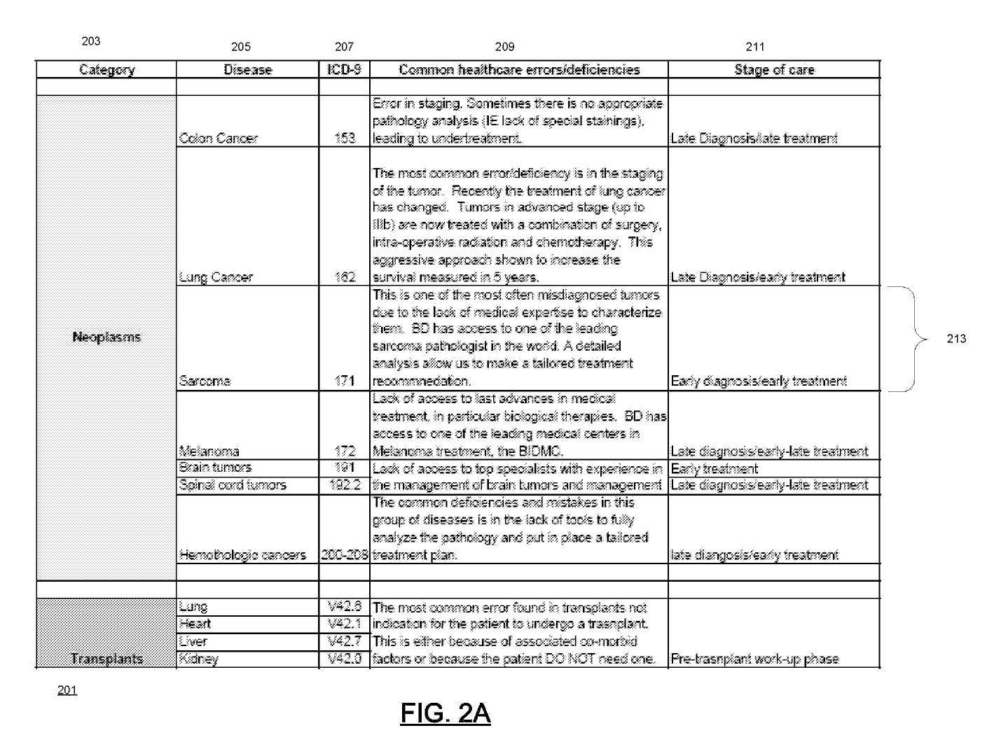

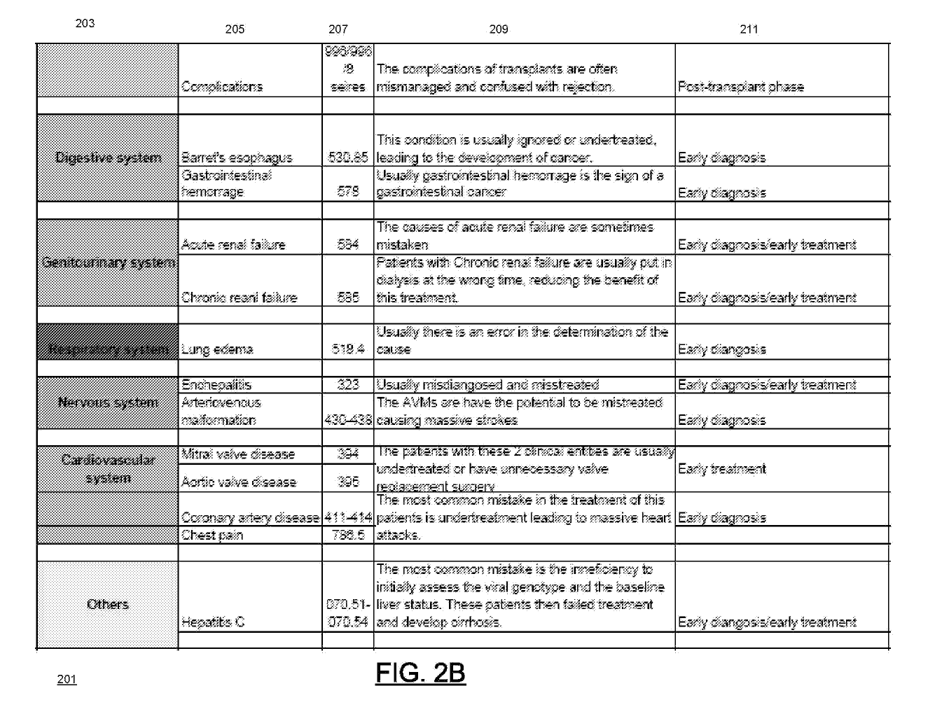

Reference numbers in the drawing have three or more digits: the two right-hand digits are reference numbers in the figure indicated by the remaining digits. Thus, an item with the reference number 203 first appears as item 203 in FIG. 2.

### DETAILED DESCRIPTION OF THE INVENTION

Medical Diagnostic and Treatment Codes

The techniques for determining whether a medical condition is a complex condition which are disclosed in the following are based on two sets of codes that are used in the United States to indicate medical conditions and treatments in medical records.
The set of codes that are used to indicate medical conditions is the ICD-9-CM (International Classification of Diseases, 9th revision, Clinical Modification) coding system. These codes are termed in the following ICD-9 codes. For example, the ICD-9 code for sarcoma is 171.
The set of codes that are used to indicate medical procedures are CPT (Current Procedural Terminology) codes and CPT is used for those codes in the following. For example, one CPT code for a biopsy is 11100.

The current CPT codes may be found in CPT 2007 Professional Edition (CPT/Current Procedural Terminology (Professional Edition)) by Michael Beebe, Joyce A. Dalton, Martha Espronceda, Desiree D. Evans, Rejina L. Glenn, American Medical Association, 2006 and the current ICD-9 codes may be found in ICD-9-CM, International Classification of Diseases, 9th Revision, Clinical Modification 6th Edition, 2007, vols. 1-3, PMIC, 2006. Both of these publications are incorporated by reference into the present patent application. In the following, both the ICD-9 codes and the CPT codes will be termed medical treatment codes

While the ICD and CPT codes were originally intended to standardize medical record keeping, other uses for them have been. One such use is in billing: the insurance companies and government agencies who are the chief payers of medical bills require that the ICD-9 code for the medical condition and the CPT code for the medical procedure are consistent with each other. For example, a bill which has an ICD 09 826.0, which indicates a closed fracture of the foot, and a CPT 31256, which indicates a nasal/sinus endoscopy, will be rejected by the payer. Because of the need for standardization of medical record keeping and because the codes are used in billing, the ICD-9 codes and the CPT codes are ubiquitous in medical records. For example, a patient's medical record in a database system belonging to an insurance company may consist of rows in a table, with each row indicating a billed medical procedure. The row will contain at a minimum the patient's name, the ICD-9 code for the medical condition that was being treated, the CPT code for the procedure, the date the medical procedure was billed, and payment information.

Using ICD-9 and CPT Codes to Determine Whether a Condition is a Complex Condition

Because medical treatment codes are ubiquitous in medical records contained in database systems and may be automatically read from those medical records, the medial treatment codes from a patient's records may be used to automatically determine whether there is a high probability that the patient has a complex condition. The insight that underlies this use of the medical treatment codes for this purpose is that unrecognized or misrecognized complex conditions are characterized by certain patterns of medical treatment codes. If these patterns are known, a patient's medical records can be analyzed to determine whether the patterns of codes that are characteristic for a given unrecognized or misrecognized complex condition exist in the patient's medical records, and if they do, expert advice on the condition should be sought for the patient.

FIG. 2 is a table which shows examples of the kind of analysis that is necessary to determine the medical treatment code patterns that are characteristic of an unrecognized or misrecognized complex condition. The table 201 of FIGS. 2A and 2B has five columns: a general category of the condition 203, a specific condition belonging to the category 205, the ICD-9 code for the specific condition 207, a description of the errors and or deficiencies that commonly occur in diagnosis and/or treatment of the condition, and the stages of care in which expert intervention may be useful.

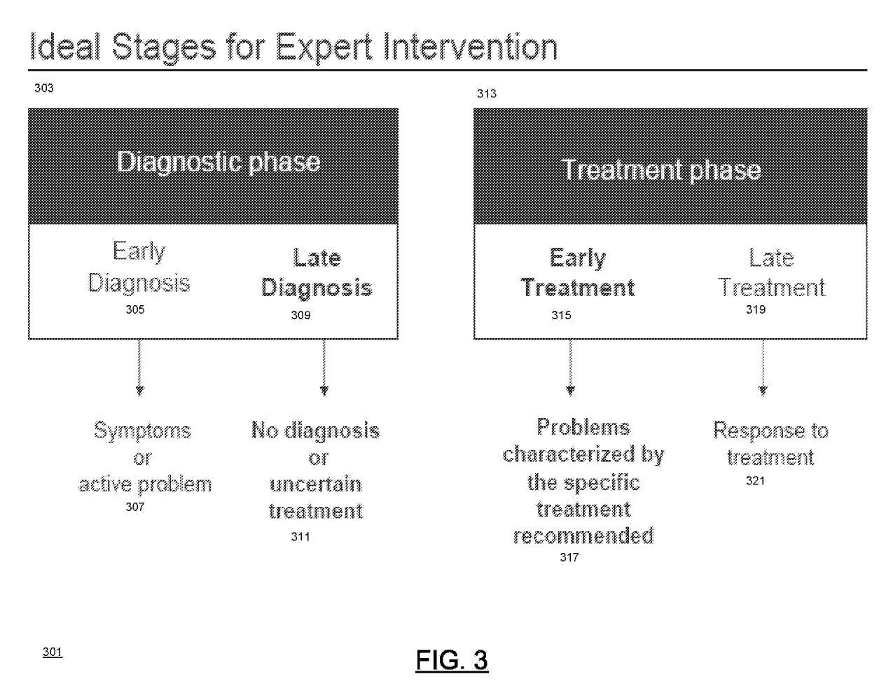

Details of the stages of care are shown at 301 in FIG. 3. In general, the response to a medical condition has two phases: a diagnostic phase 303 and a treatment phase 313. In the diagnostic phase, there are two subphases: early diagnosis 305, in which the doctor is dealing with symptoms or an active problem (307), and late diagnosis 309. If there is still no diagnosis, or if there is a diagnosis, but it is not clear what the best treatment is (311), expert intervention is advisable. In the treatment phase, there are again two subphases, early treatment 315 and late treatment 319. Early treatment is of course the place where problems caused by the specific treatment recommended in the diagnostic phase are most likely to occur (317), and if they do, expert intervention is also advisable. With late treatment, the issue is how the disease is responding to the treatment (319). If a better response is possible, expert intervention may also be advisable there.

Taking row 213 of table 201 as an example, here, the category is neoplasms, the specific neoplasm is sarcoma, and the common errors/deficiencies are misdiagnosis of the tumor and failure to tailor the treatment of the tumor to the kind of tumor. Because the main issues are misdiagnosis of the tumor and the tailoring of the treatment to the tumor, expert intervention is most useful in the early diagnosis stage 305 and/or the early treatment stage 315.

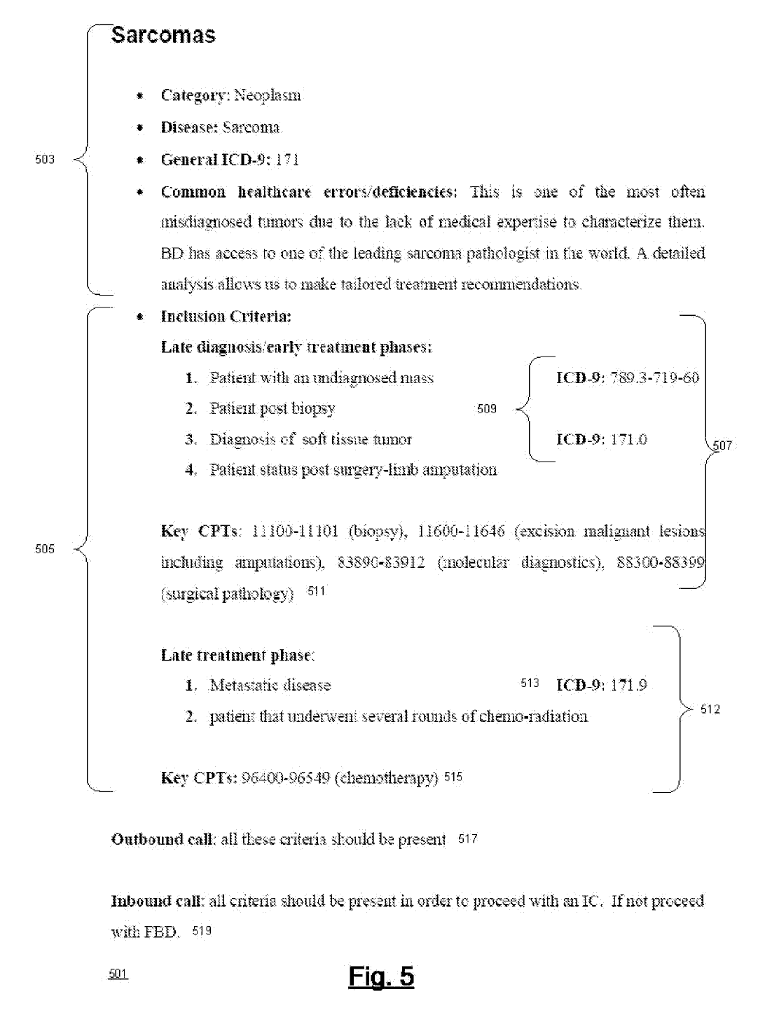

FIG. 5 shows at 501 how the analysis shown in table 201 moves from the errors/deficiencies of column 209 that are typical for the diagnosis and/or treatment of a disease to determining a pattern of medical treatment codes which indicates that intervention by an expert is advisable. The figure continues the sarcoma example from column 213. At 503, the information from columns 203-209 of row 213 is repeated. At 505, the patterns of medical treatment codes which indicate that expert intervention is advisable are determined. The patterns vary according to the phases of treatment shown in FIG. 3. Thus, in the case of sarcoma, there is one set of patterns shown at 507 that indicate that expert intervention may be advisable during the late diagnosis phase 309 and/or the early treatment phase 315 and another set shown at 512. The ICD-9 codes that indicate a need for expert intervention during late diagnosis and/or early treatment are shown at 509; the CPT codes that indicate a need for expert intervention are shown at 511. As set forth at 517 and 519, various combinations of the ICD-9 codes and CPT codes may indicate the need for intervention. In a presently-preferred embodiment, intervention is indicated if any of the ICD-9s listed in FIG. 5 is present and at least one of the listed CPTs is present. Also if the sarcoma ICD-9 171.x is present and there is an absence of any of the listed CPTs, intervention is indicated, since this combination indicates that the patient has a sarcoma but remains untreated. Similarly, as shown at 511, the criteria that indicate the need for expert intervention in the late treatment phase are combinations of an ICD-9 code of 171.9, shown at 513, and a CPT code from the range of CPTs indicated at 515.

It should be pointed out there that the medical treatment codes which provide the basis for the technique need not be the ICD-9 codes or the CPT codes. Any standard set of medical treatment codes may be used, and indeed, if there is a standard terminology for medical treatment which is used throughout the patient records in question, the “medical treatment code patterns” may be patterns of terms in the standard terminology. It should also be pointed out here that medical treatment code patterns have uses beyond determining whether a complex condition exists. For example, if a medical advance has occurred and there are patterns of medical treatment codes that indicate that treatment based on the advance would be useful for a patient, candidates for the treatment could be found by scanning the patient records for those patterns. More generally, the medical treatment code patterns can be used in any situation where a linkage between the code patterns and treatment of a patient exists.

Situations in which Medical Treatment Code Patterns May be Used to Determine Whether a Complex Condition Exists

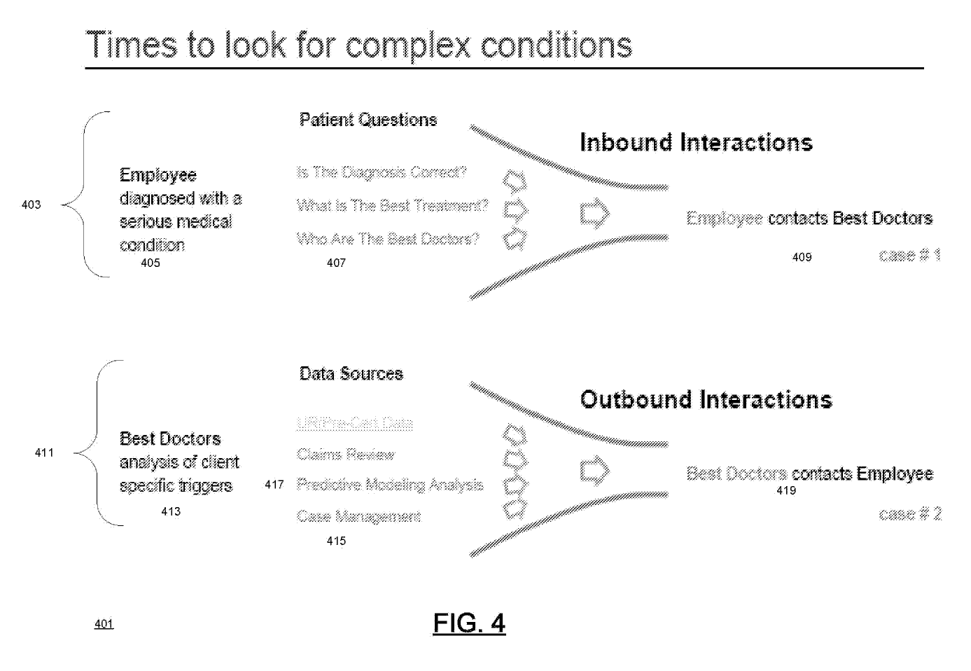

In general, medical treatment code patterns may be used to determine whether a complex condition exists in any situation where there are medical records for the patient that contain medical treatment codes. However, two situations where their use is particularly beneficial are after a patient has obtained an initial diagnosis and during management of a chronic condition. These two situations are shown at 401 in FIG. 4. The first situation, shown at 403, occurs when a patient is diagnosed with a serious medical condition (405). Either the patient or the patient's insurer may then want to determine whether the diagnosis is correct and what the best treatment is (407). Part of that process is of course determining whether a complex condition exists. As will be explained in more detail in the following, that is done at 409. In FIG. 5, this first situation is termed an “Inbound Call”, and as shown at 519, if the medical treatment code patterns specified in FIG. 5 exist in this situation, there should be an “IC”. “IC” is an acronym for InterConsultation, a program run by Best Doctors, Inc. of Boston, Mass. for providing expert intervention to deal with the complex condition.

The second situation, shown at 411 in FIG. 4, occurs when a party, most often the insurer, is paying for treatment of a chronic condition. The insurer of course wants to obtain the best quality of life for the patient and the lowest cost of treatment. That is possible only if the chronic condition was correctly diagnosed in the first place and the optimum treatment is being given. In this situation, the records of the patient being treated for the chronic condition can be examined for patterns of medical treatment codes that indicate that a complex condition exists and that expert intervention is consequently desirable. In this situation, specific triggers such as cost or recurrence of acute conditions indicate to the insurer that the patient's treatment needs to be reviewed (413). The patient's records are then examined for relevant patterns of medical treatment codes at 415 (the techniques disclosed herein are one type of predictive modeling analysis 417), and if the relevant patterns are found, Best Doctors contacts the patient and sets up the expert intervention (419). This case appears at 511 in FIG. 5, and as indicated at 515, for such an “outbound call”, all of the criteria should be present for an “IC”. Of course, the specific triggers of 413 could also be patterns of medical treatment codes that indicate that a complex condition exists.

Bringing the Expert and the Patient Together

The techniques for determining whether a complex condition exists that have just been described were developed at Best Doctors, Inc., located at One Boston Place, Boston, Mass. Best Doctors functions as an intermediary between consumers of medical services and medical specialists. When a doctor requires a specialist for a patient, the patient him/ or herself believes that a specialist is required, or an insurer finds evidence that a patient's care is not being optimally managed, Best Doctors performs services for the patent including
determining whether a specialist is necessary;
finding a specialist for the patient's condition and referring the patient to the specialist;
collecting the patient's medical records;
packaging the information contained in the patient's medical records together with medical information about the condition in a manner which is optimal for the specialist; and providing the specialist with the packaged information.

The medical records are collected by nurses who are trained in questioning patients about their medical histories and in locating and obtaining medical records. The information from the patient's records and the medical information is collected and packaged by residents at Harvard Medical School.

The techniques just described may are part of the process of determining whether a specialist is necessary and of finding the specialist when one is. For example, when a specialist is requested, the patient's records can be examined for patterns of medical treatment codes that indicate a complex condition. If no complex condition exists, no specialist may be necessary; if a complex condition does exist, the case requires a different kind of intervention by the specialist and maybe even a different specialist from what would be required if there were no complex condition. Similarly, when an insurance company flags a patient with a chronic condition for a review of his or her treatment, Best Doctors can search that patient's records for patterns of medical treatment codes that indicate a complex condition. Best Doctors may also search the records of groups of patients for the insurance company to determine whether there are any patients whose records have patterns of medical treatment codes that show that the patients have a complex condition or are otherwise not receiving optimal care.

Using a Relational Database System to Find Patterns of Medical Treatment Codes

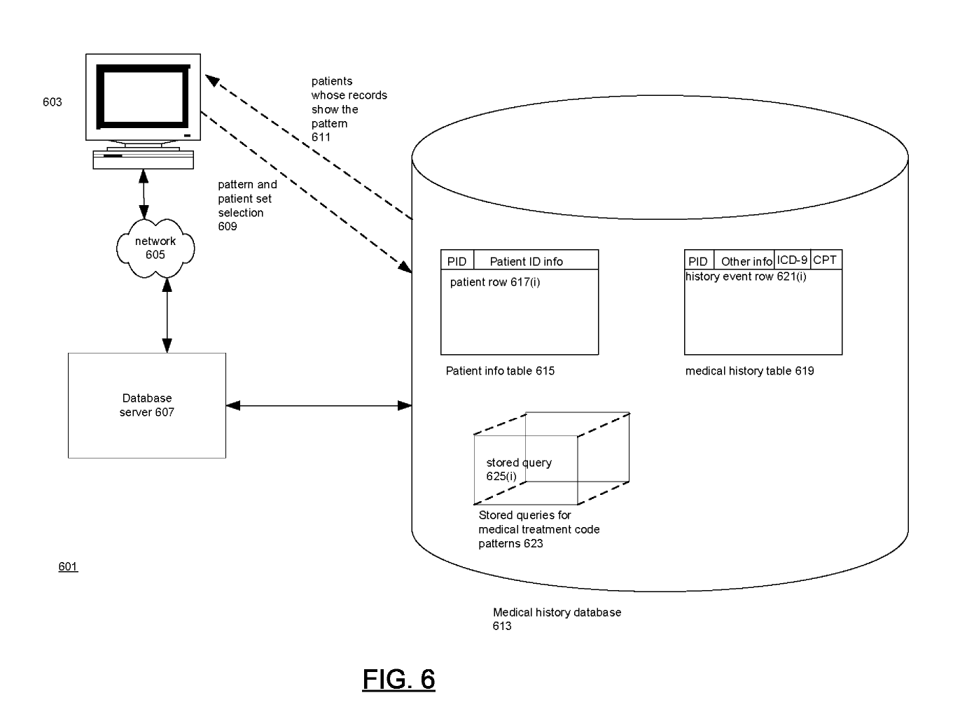

While a search of medical records for a particular pattern of medical treatment codes can be made in many ways, in the context of modern medical practice it will most probably be made using a relational database system that contains medical history information for a group of patients. A block diagram of such a relational database system is shown at 601 in FIG. 6. Chief components of the system are client workstation 603, from which the database is queried, database server 607, and database 613. Workstation 603 is connected via a network 605 of any kind to database server 607. In response to inputs from workstation 603, database server 607 executes queries on medical history database 613 and returns the results of the queries to client workstation 603. Medical history databases may of course be exceedingly complex, but for the present purpose, the database may be considered to have two tables and a set of stored queries. The first table is patient info table 615, which has a row for each patient. The row contains a database system identifier for the patient (PID) and identification information about the patient such as the patient's name, contact information, and billing information. The second table is medical history table 619, which has a row 621 for each of the medical history events that are recorded for each of the patients in patient info table 615. Each row is related to the patient to whom the event occurred by the patient's PID. Included in the information about the event are the ICD-9 and CPT codes for the event. Stored queries 623 are queries which specify patterns of medical treatment codes that are of interest for the entity which is responsible for system 601.

Operation of the system is as follows: a graphical user interface which is provided by database server 607 to client workstation 603 permits the user of workstation 603 to specify a pattern of interest and a set of patients whose records are to be examined to see whether the pattern is present, as shown at 609. The result 611 of the query is a list of patients from the set for whom the pattern is present. In one embodiment, the user might specify the pattern by means of the ICD-9 code for the condition for which the pattern is of interest. If there is only one patient in the set, the set can be specified by the patient's name; otherwise, it may be specified by a list of names or in the case of periodic screening queries, by the date of the last screening (contained in the patient ID info in table 615).

When database server 607 receives pattern and patient set selection 609, it provides medical history database 613 with a query which applies stored query 625(j) for the selected pattern to the records for each of the patients in the set in medical history table 619. If the pattern is found, the patient is included in the list 611 provided by the query result. Thus, if the set of patients consists of a single patient and no result is returned, the patient's records do not show the pattern; if the patient's name is returned, they do. Of course, information from patient info table 615 about the table could be returned as part of the result, as well as information from the records 621 for the patient in medical history table 619 that had codes belonging to the pattern.

### CONCLUSION

The foregoing Detailed Description has disclosed to those skilled in the relevant technologies the inventors' techniques for using medical treatment codes in a patient's records to determine a particular manner in which a medical condition of an individual should be dealt with. The Detailed Description has further disclosed the best mode presently known to the inventors of practicing their techniques. It will, however, immediately be apparent to those skilled in the relevant technologies that there are many ways of implementing the techniques in addition to the ones disclosed herein and many uses for the techniques in addition to the ones disclosed herein.

For example, as would be expected from the fact that the techniques are implemented in the United States, the medical treatment codes employed in the invention are the ICD-9 and CPT codes, but any kind of medical treatment codes may be employed, including a uniform nomenclature for diagnoses and medical procedures. Further, as would be expected by the nature of their business, the inventors use their techniques to determine when intervention by a specialist is necessary and to determine what sort of specialist is needed, but the techniques can be used generally to help determine what kind of medical treatment is needed for a patient.

For all of the foregoing reasons, the Detailed Description is to be regarded as being in all respects exemplary and not restrictive, and the breadth of the invention disclosed here in is to be determined not from the Detailed Description, but rather from the claims as interpreted with the full breadth permitted by the patent laws.

1. A method of determining a particular manner in which a medical condition of an individual should be dealt with from a set of medical records that belong to the individual and contain medical treatment codes, the method comprising the steps of:
analyzing the set of medical records to determine whether the set of medical records contains a pattern of the medical treatment codes that is associated with the particular manner of dealing with the medical condition and
when the set of medical records does contain such a pattern, providing an indication of the pattern's existence.

2. The method set forth in claim 1 wherein:
the particular manner of dealing with the medical condition is consulting an expert.

3. The method set forth in claim 2 wherein:
the expert belongs to a class of experts that is associated with the pattern of the medical treatment codes.

4. The method set forth in claim 1 further comprising the step of:
responding to the indication of the pattern's existence by dealing with the medical condition in the particular manner associated with the pattern of the medical treatment codes.

5. The method set forth in claim 1 wherein:
the analysis can be made at a plurality of points during the medical condition; and
the pattern and the particular manner of dealing with the medical condition associated therewith depend on when the analysis is made.

6. The method set forth in claim 5 wherein:
the step of analyzing the set of medical records is taken when the diagnosis of the medical condition is uncertain.

7. The method set forth in claim 5 wherein:
the step of analyzing the set of medical records is taken when the treatment of the medical condition is uncertain.

8. The method set forth in claim 5 wherein:
the step of analyzing the set of medical records is taken when the treatment of the medical condition results in further problems.

9. The method set forth in claim 5 wherein:
the step of analyzing the set of medical records is taken when the individual does not respond to the treatment.

10. The method set forth in claim 1 wherein:
the individual is one of a first set thereof;
the step of analyzing is done for each of the individuals in the first set; and
the step of providing an indication of the pattern's existence is performed by placing individuals whose sets of medical records contain the pattern into a second set of individuals.

11. The method set forth in claim 1 wherein
the set of medical records is contained in a database system; and
the step of analyzing includes the steps of:
querying the set of records with a query based on the pattern of the medical treatment codes; and
determining from the result of the query whether the set of records does contain such a pattern.

12. Storage apparatus characterized in that:
the storage device contains a query which, when executed, performs the step of querying the set of records as set forth in claim 11.

13. A method of reducing the cost of a treatment of a medical condition of an individual comprising the steps of:
analyzing a set of medical records of the individual, the medical records containing medical treatment codes, to determine whether the set of medical records contains a pattern of the medical treatment codes that indicates that the medical condition is a complex medical condition; and
when the set of medical records does contain such a pattern, indicating that an expert should be consulted concerning the medical condition.

14. The method set forth in claim 13 wherein:
the expert belongs to a class of experts that is associated with the pattern of the medical treatment codes.

15. The method set forth in claim 13 wherein:
the step of analyzing can be performed at a plurality of points during the medical condition; and
the pattern depends on when the analysis is made.

16. The method set forth in claim 15 wherein:
the step of analyzing the set of medical records is taken when the diagnosis of the medical condition is uncertain.

17. The method set forth in claim 15 wherein:
the step of analyzing the set of medical records is taken when the treatment of the medical condition is uncertain.

18. The method set forth in claim 15 wherein:
the step of analyzing the set of medical records is taken when the treatment of the medical condition results in further problems.

19. The method set forth in claim 15 wherein:
the step of analyzing the set of medical records is taken when the individual does not respond to the treatment.

20. The method set forth in claim 13 wherein
the set of medical records is contained in a database system; and
the step of analyzing includes the steps of:
querying the set of records with a query based on the pattern of the medical treatment codes; and
determining from the result of the query whether the set of records does contain such a pattern.

21. The method set forth in claim 13 wherein:
the individual is one of a first set thereof;
the step of analyzing is done for each of the individuals in the first set; and
the step of indicating that an expert should be consulted is performed by placing individuals whose sets of medical records contain the pattern into a second set of individuals for whom the expert should be consulted.

22. A method of providing expert intervention with regard to a medical condition in an individual, the method comprising the steps of:
analyzing a set of medical records for the individual to determine whether the the set of medical records contains a pattern of medical treatment codes which indicates that the medical condition requires expert intervention of a particular type; and
if the set of medical records does contain such a pattern, referring the individual to an expert who can provide intervention of the particular type.

23. The method set forth in claim 22 further comprising the step of:
collecting the medical records belonging to the set.

24. The method set forth in claim 23 further comprising the steps of:
collecting additional medical information about the medical condition in addition to the medical records;
making a package of information from the additional medical information and from the medical records which presents the information a way that is optimal for the expert to whom the individual is being referred; and
providing the package to the expert to whom the individual is being referred.

25. The method set forth in claim 22 further comprising the steps of:
collecting additional medical information about the medical condition;
making a package of information from the additional medical information and from the medical records which presents the information a way that is optimal for the expert to whom the individual is being referred; and
providing the package to the expert to whom the individual is being referred.
